(19) United States
(12) Patent Application Publication
(10) Pub. No.: US 2026/0011996 A1
(43) Pub. Date: Jan. 8, 2026

(54) CHARGER

(71) Applicant: LG ELECTRONICS INC., Seoul (KR)

(72) Inventors: Suk KO, Seoul (KR); Kangsuk LEE, Seoul (KR); Sunghwan OH, Seoul (KR); Myoungku LEE, Seoul (KR); Sunghoon KANG, Seoul (KR)

(73) Assignee: LG ELECTRONICS INC., Seoul (KR)

(21) Appl. No.: 18/824,198

(22) Filed: Sep. 4, 2024

(30) Foreign Application Priority Data
Jul. 2, 2024 (KR) 10-2024-0086635

(51) Int. Cl. H02G 11/00; B60L 53/18

(52) U.S. Cl. CPC H02G 11/003; B60L 53/18

(57) ABSTRACT

A charger according to the present embodiment comprises a body with a space formed inside; a door configured to open and close the space; a retractor module including a retractor having a wire connected to a charging cable and a box configured to cover the retractor; and a retractor cover disposed on an upper side surface of the body and configured to cover the retractor module when the retractor module is inserted.

### CROSS-REFERENCE TO RELATED APPLICATION

Pursuant to 35 U.S.C. § 119 (a), this application claims the benefit of earlier filing date and right of priority to Korean Patent Application No. 10-2024-0086635, filed on Jul. 2, 2024, the contents of which are hereby incorporated by reference herein in its entirety.

### BACKGROUND

The present disclosure relates to a charger for charging vehicles such as electric vehicles.

A charger is a device used to charge storage batteries.

The charger may be an electric vehicle charger that charges vehicles such as electric vehicles, and may supply electric energy to the battery of the electric vehicle by connecting the connector provided at the end portion of the charging cable to the connection inlet installed in the electric vehicle.

The user may connect to the vehicle after taking out the connector (charging gun or plug) provided on the charging cable from the body of the charger.

The charger may comprise a reel on which the charging cable is wound, and a retractor that controls the rotation or fixation of the reel, an example of a charger with a retractor is an electric vehicle charging device which is disclosed in Republic of Korea Patent Publication No. 10-1967149 B1 (Published on Apr. 9, 2019), and the electric vehicle charging device comprises a main body installed on an electric pole and configured to supply power to the electric vehicle; a charger configured to be electrically connected to the electric vehicle; a charging cable configured to electrically connect the main body and the charger; a reel configured to wind the charging cable by rotation; a retractor that controls rotation or fixation of the reel; a protrusion configured to protrude from the inside to the outside of the main body; and a holder connected to the protrusion outside the main body and supporting a portion of the charging cable.

### SUMMARY

An object of this embodiment is to provide a charger that is easy to install and replace the retractor and has a simple outer appearance by hiding the retractor as much as possible.

A charger according to the present embodiment may comprise a body with a space formed inside; a door configured to open and close the space; a retractor module including a retractor having a wire connected to a charging cable and a box configured to cover the retractor; and a retractor cover disposed on an upper side surface of the body and configured to cover the retractor module when the retractor module is inserted.

The retractor cover may comprise an inner space where the retractor module is accommodated; an entrance through which the retractor module enters and exits; and a wire through-hole through which the wire passes.

A drainage channel may be formed on the retractor cover.

An opening direction of the wire through-hole and an opening direction of the drainage channel may be different.

The drainage channel may open toward a rear surface of the door.

The charger may further comprise a door gasket disposed between the body and the door.

The drainage channel may be open toward an outside of the door gasket.

The retractor module may further comprise a handle installed on the box.

The box may comprise a cover base configured to cover one side of the retractor; and a cover top configured to cover other side of the retractor.

The retractor cover may comprise an inner portion hidden by the door and an outer portion exposed to an outside of the body.

The body may comprise a fastening body.

An example of the retractor cover may be coupled to the fastening body by a fastening member.

The retractor cover may be seated on the fastening body and the retractor cover may be fastened to the fastening body with a fastening member.

The fastening body may comprise a seating portion on which a portion of the retractor cover is seated.

The fastening body may further comprise a fastening portion formed to be long in a vertical direction and having a through-hole through which the fastening member passes.

The seating portion may be disposed horizontally below the fastening portion.

The door may cover the fastening body.

Another example of the retractor cover may be a protruding body formed to protrude from the body.

A seating body that is seated on the reflector cover may be formed on the box.

The seating body may be bent horizontally at an upper portion of the box.

A stepped portion on which the seating body is seated may be recessed in an upper portion of the retractor cover.

The retractor comprises a retractor case forming an exterior of the retractor.

The box may cover a front surface, a rear surface, and peripheral surfaces of the retractor.

Another example of a charger according to the present embodiment comprises a body with a space formed inside; a door configured to open and close the space; a retractor having a wire connected to a charging cable; and a retractor cover disposed on an upper side surface of the body and configured to cover the retractor when the retractor is inserted.

### BRIEF DESCRIPTION OF THE DRAWINGS

FIG. 1 is a perspective view illustrating a case where the retractor cover is separated from the body of an example of the charger according to this embodiment and the retractor module is separated from the retractor cover,

FIG. 2 is a perspective view illustrating the retractor module according to this embodiment,

FIG. 3 is an exploded perspective view illustrating the retractor module according to this embodiment,

FIG. 4 is an exploded perspective view illustrating the retractor according to this embodiment,

FIG. 5 is a front view illustrating a case where the door according to this embodiment is separated from the body,

FIG. 6 is a perspective view illustrating the rear surface of the body and the rear surface of the retractor cover before the retractor cover according to this embodiment is assembled to the body, and

FIG. 7 is a perspective view illustrating a case where the retractor module is separated from the body of another example of the charger according to this embodiment.

### DETAILED DESCRIPTION OF THE EMBODIMENTS

Hereinafter, specific embodiments of the present disclosure will be described in detail along with the drawings.

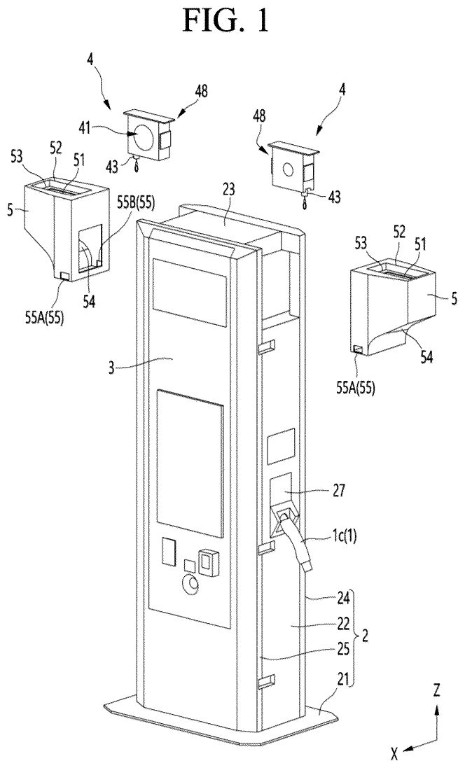

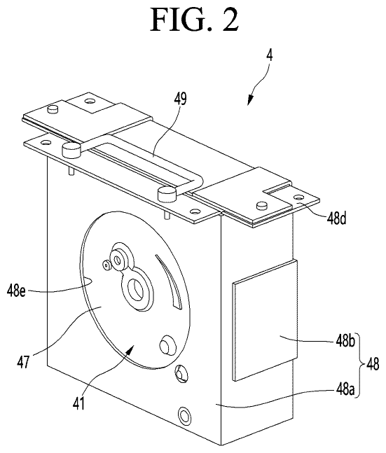

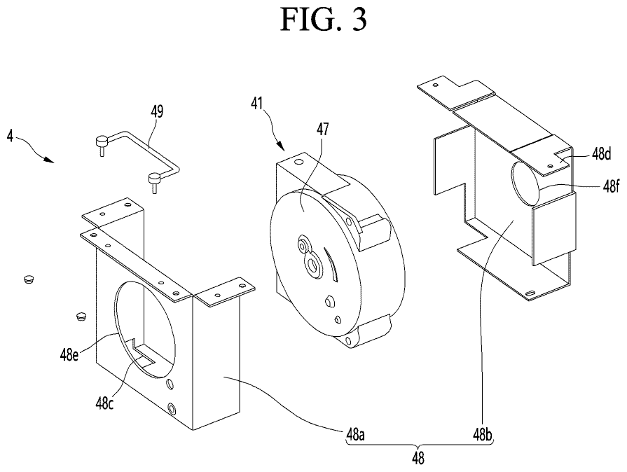

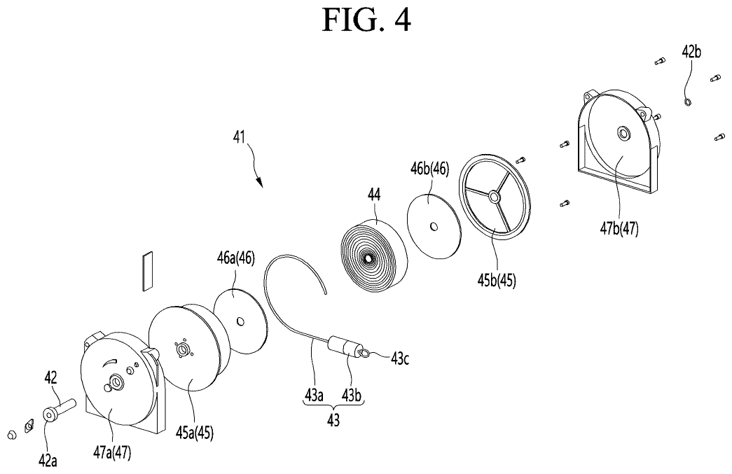

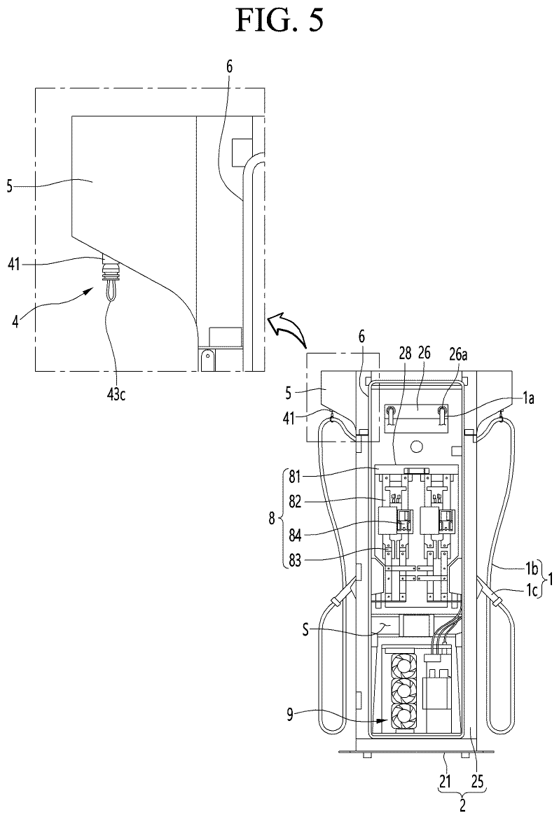

FIG. 1 is a perspective view illustrating a case where the retractor cover is separated from the body of an example of the charger according to this embodiment and the retractor module is separated from the retractor cover, FIG. 2 is a perspective view illustrating the retractor module according to this embodiment, FIG. 3 is an exploded perspective view illustrating the retractor module according to this embodiment, FIG. 4 is an exploded perspective view illustrating the retractor according to this embodiment, and FIG. 5 is a front view illustrating a case where the door according to this embodiment is separated from the body.

The charger may comprise a charging cable 1, a body 2, a door 3, a retractor module 4, and a retractor cover 5.

The charging cable 1 may be disposed through the body 2. The charging cable 1 may comprise an inner cable 1a located inside the body 2 and an outer cable 1b located outside the body 2.

The outer cable 1b may be connected to the wire 43 of the retractor module 4.

One end of the charging cable 1 may be connected to the connection module 7 accommodated inside the body 2, and in the other end of the charging cable 1, a connector 1c (or charging gun) that is connected to/disconnected from a vehicle such as an electric vehicle may be disposed.

A connection body connected to the connection module 7 may be disposed on the inner cable 1a of the charging cable 1

A connector 1c may be disposed on the outer cable 1b of the charging cable 1.

The body 2 may form the outer appearance of the charger.

A space S may be formed inside the body 2.

The body 2 may comprise a base 21, a left plate 22, a right plate, a top cover 23, a rear plate 24, and a front plate 25.

The body 2 may be provided with a cable gland 26 through which the charging cable 1 passes.

A through-hole 26a through which the charging cable 1 passes may be formed in the cable gland 26.

The cable gland 26 may be disposed on the upper portion of the rear plate 24 of the body 2.

A holder 27 on which the connector of the charging cable 1 is mounted may be disposed on at least one of the left plate 22 and the right plate of the body 2.

An opening 28 may be formed in the front surface of the body 2. An opening 28 smaller than the door 3 may be formed in the front plate 25 of the body 2.

The door 3 may open and close the space S. The door 3 may be placed in front of the front plate 25 of the body 2 and may shield the opening 28.

The door 3 may be disposed to rotate or slide on the body 2.

The charger may further comprise a door gasket 6.

The cross-sectional shape of the door gasket 6 may be a closed loop shape, and the inner area of the door gasket 6 may be a waterproof area. The outer area of the door gasket 6 may be a non-waterproof area.

The door gasket 6 may be disposed between the body 2 and the door 3.

The door gasket 6 may be placed between the front surface of the body 2 and the rear surface of the door 3 and minimize the penetration of foreign substances such as rainwater or dust between the body 2 and the door 3.

The charger may further comprise a connection module 8 and a chiller 9.

The connection module 8 may be accommodated in the space S and may be protected by the body 2 and the door 3 inside the body 2.

The connection module 8 may comprise a bracket 81 mounted on the body 2, a bus bar 82 installed on the bracket 81, a relay 83 in contact with the bus bar 82, and a meter 84 measuring the amount of electricity.

The chiller 9 may be accommodated in the space S and may be protected by the body 2 and the door 3 inside the body 2.

Examples of the chiller 9 may comprise a refrigeration cycle device including a compressor, condenser, expander, and evaporator.

The retractor module 4 may comprise a retractor 41.

As illustrated in FIG. 4, the retractor 41 may comprise a shaft 42, a wire 43, a leaf spring 44, a drum 45, an inner plate 46, and a reflector case 47.

The shaft 42 may penetrate the leaf spring 44, the inner plate 46, and the reflector case 47.

A head portion 42a that is caught by the reflector case 47 may be formed on one end of the shaft 42, and a ring 42b fixed to the shaft 42 may be fastened to the other end of the shaft 42.

The wire 43 may comprise a wire member 43a and a connection body 43b.

One end of the wire member 43a may be connected to at least one of the leaf spring 44 or the drum 45.

The loose portion of the wire 43 may be exposed to the lower end of the retractor cover 5.

The connection body 43b is connected to the other end of the wire member 43a and may be connected to the outer cable 1b of the charging cable 1.

An example of the connection body 43b may comprise a hook or loop 43c surrounding one side of the outer cable 1b of the charging cable 1.

The leaf spring 44 may be wound spirally. The inner end of the leaf spring 44 may be disposed on the shaft 42.

The drum 45 may comprise a drum body 45a surrounding the outer circumference of the leaf spring 44 and a drum cover 45b coupled to the drum body 45a with a fastening member such as a screw.

The drum 45 may be rotated inside the reflector case 47.

The inner plate 46 may minimize wear between the leaf spring 44 and the drum 45.

A pair of inner plates 46 may be provided with the leaf spring 44 interposed therebetween, and the pair of inner plates 46 may comprise a first inner plate 46a disposed between the drum body 45 and the leaf spring 44, and a second inner plate 46b disposed between the leaf spring 44 and the drum cover 45b.

The retractor case 47 forms an exterior of the retractor 41.

The retractor case 47 may comprise a top case 47a surrounding the outer circumference of the drum 46, and a bottom case 47b coupled to the top case 47a with a fastening member such as a screw.

When the connector 1c is pulled, the retractor 41 allows the wire 43 connected to the outer cable 1b to come out. When the user mounts the connector 1c on the holder 27, the leaf spring 44 may restore the wire 43 while winding.

The retractor module 4 may comprise a box 48 covering the retractor 41.

The box 48 may surround the retractor 41 from the outside of the retractor 41.

The box 48 may cover the front surface, the rear surface, and peripheral surfaces of the retractor 41.

The box 48 may comprise a cover base 48a that covers one side of the retractor 41; and a cover top 48b that covers the other side of the retractor 41.

The cover base 48a and cover top 48b may protect the retractor 41.

An inner through-hole 48c through which the wire 43 of the retractor 41 passes may be formed in at least one of the cover base 48a and the cover top 48b.

The retractor 41 may be accommodated between the cover base 48a and the cover top 48b.

A seating body 48d that is seated on the reflector cover 5 may be formed on the box 48.

The seating body 48d may be bent horizontally at the upper portion of the box 48.

The seating body 48d may be formed on at least one of the cover base 48a and the cover top 48b.

The cover base 48a and the cover top 48b may be fastened with a fastening member such as a screw.

A retractor space in which the retractor 41 is accommodated may be formed between the cover base 48a and the cover top 48b.

An opening 48e may be formed in the cover base 48a to accommodate the shaft penetrating portion formed on the front surface of the reflector 41.

An opening 48f may be formed in the cover top 48b to accommodate the shaft penetrating portion formed on the rear surface of the reflector 41.

The retractor module 4 may further comprise a handle 49.

The handle 49 may be installed in the box 42. When mounting or dismounting the retractor module 4, the user may easily carry the retractor module 4 by holding the handle 49.

The handle 49 may be mounted on either the cover base 48a or the cover top 48b.

The handle 49 may be rotatably mounted on the cover base 48a or the cover top 48b.

The retractor module 4 may be installed by inserting into the retractor cover 5.

When the retractor module 4 is inserted into the retractor cover 5, the retractor module 4 may be covered by the retractor cover 5 and protected by the retractor cover 5.

When the retractor module 4 is inserted into the retractor cover 5, the retractor module may be hidden in the retractor cover 5.

When servicing or replacing the retractor 41, the operator may hold the handle 49 and lift the retractor module 4, and the retractor module 4 may be easily pulled upward from the retractor cover 5.

The retractor cover 5 may cover the retractor module 4 from the outside of the retractor module 4.

The retractor cover 5 may be disposed on the upper side surface of the body 2.

An inner space 51 in which the retractor module 4 is accommodated may be formed in the retractor cover 5.

The retractor cover 5 may be formed with an entrance 52 through which the retractor module 4 enters and exits.

The cross-sectional area of the entrance 52 may be larger than the cross-sectional area of the inner space 51.

A stepped portion 53 on which the seating body 48d illustrated in FIG. 2 may be seated may be recessed in the upper portion of the retractor cover 5.

A wire through-hole 54 through which the wire 43 of the retractor 4 passes may be formed in the retractor cover 5.

The wire through-hole 54 may be opened in a vertical or oblique direction.

A drainage channel 55 may be formed in the retractor cover 5.

The opening direction of the wire through-hole 54 and the opening direction of the drainage channel 55 may be different.

The opening direction of the wire through-hole 54 and the opening direction of the drainage channel 55 may be perpendicular to each other.

The opening direction of the wire through-hole 54 may be the vertical direction Z.

The opening direction of the drainage channel 55 may be the front and rear direction X.

The drainage channel 55 may be an opening formed in the retractor burr 5.

The drainage channel 55 may be open toward the rear surface of the door 3.

The door 3 may cover the drainage channel 55 in front of the drainage channel 55.

A pair of drainage channels 55 may be formed on the retractor cover 5.

A pair of drainage channels 55 may comprise a front drainage channel 55A formed on the front plate body of the retract box 5, and a rear drainage channel 55B formed on the rear plate body of the retract box 5.

The front drainage channel 55A and the rear drainage channel 55B may be open in the front and rear direction X at the lower portion of the retractor cover 5.

The drainage channel 55 may be open toward the outside of the door gasket 6.

The water flowing into the drainage channel 55 does not penetrate into the inner area of the door gasket 6 illustrated in FIG. 5 and may fall downward along the front surface of the front plate 25 of the body 2 or the rear surface of the door 3.

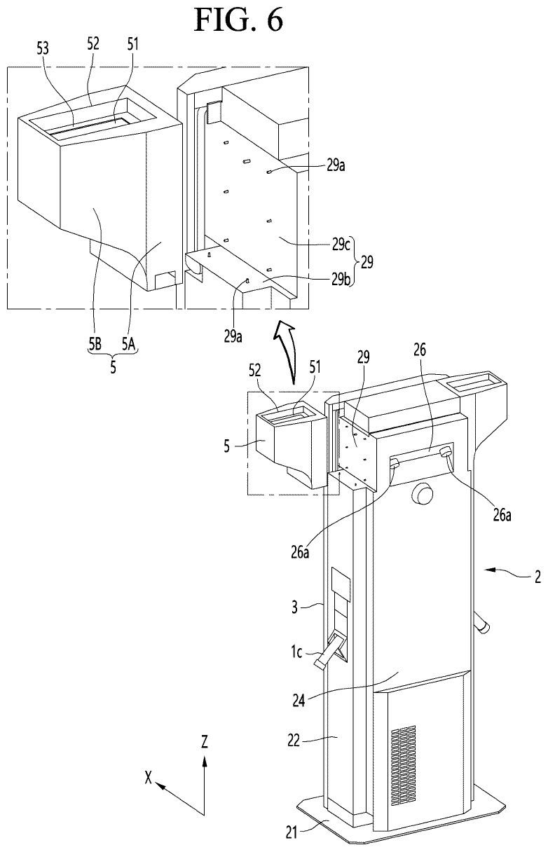

FIG. 6 is a perspective view illustrating the rear surface of the body and the rear surface of the retractor cover before the retractor cover according to this embodiment is assembled to the body.

The body 2 may comprise a fastening body 29.

The retractor cover 5 may be seated on the fastening body 29. The retractor cover 5 may be fastened to the fastening body 29 with a fastening member 29a.

The fastening body 29 may comprise a seating portion 29b and a fastening portion 29c.

A portion of the retractor cover 5 may be seated on the seating portion 29b. The seating portion 29b may be horizontally disposed below the fastening portion 29c. The seating portion 29b may be horizontally bent at the lower portion of the fastening portion 29c.

The seating portion 29b may be positioned to be obscured by the door 3.

The fastening member 29a, such as a screw, may be fastened to the retractor cover 5 after passing through the through-hole formed in the seating portion 29b in the space S of the body 2.

The fastening portion 29c may be positioned to be obscured by the door 3.

The fastening portion 29c may be formed to be long in the vertical direction Z.

The fastening member 29a, such as a screw, may be fastened to the retractor cover 5 after passing through the through-hole formed in the fastening portion 29c in the space S of the body 2.

The door 3 may shield the space S formed inside the body 2 from the front of the body 2.

The door 3 may overlap the fastening body 29 in the front and rear direction X.

The door 3 may cover the fastening body 29 in front of the fastening body 29.

The retractor cover 5 may comprise an inner portion 5A and an outer portion 5B.

The inner portion 5A of the retractor cover 5 may be partially inserted into the recessed space formed on the side of the body 2, and the portion inserted into the recessed space may be hidden by the door 3.

The inner portion 5A of the retractor cover 5 may be a hidden portion that is hidden by the door 3.

The outer portion 5B of the retractor cover 5 may be exposed to the outside of the body 2. The outer portion 5B) of the retractor cover 5 may protrude out of the body (2) in the left and right direction Y.

The outer portion 5B of the retractor cover 5 may be an exposed portion that is not hidden by the door 3.

The fastening member 29a may penetrate the through-hole formed in the fastening body 29 from the inside of the body 2 and may be fastened to the fastening hole formed in the retractor cover 5.

Since the retractor cover 5 is fastened to the fastening body 29 by the fastening member 29a fastened from the inside of the body 2, if the door 3 is not opened, the retractor cover 5 may not be removed, and thus the retractor cover 5 may be reliably maintained on the body 2.

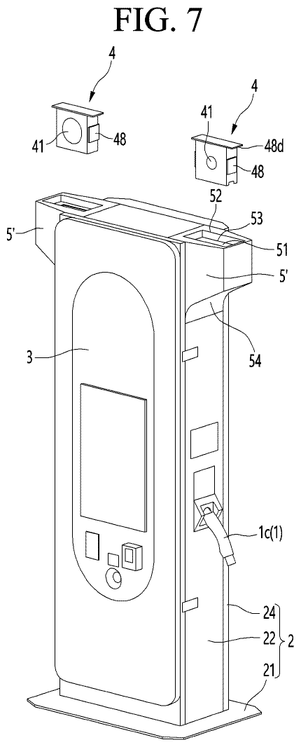

FIG. 7 is a perspective view illustrating a case where the retractor module is separated from the body of another example of the charger according to this embodiment.

In this embodiment, as illustrated in FIG. 7, the retractor cover 5′ covering the retractor module 4 may be formed integrally with the body 2, and other configurations and operations other than that the retractor cover 5′ is formed integrally with the body 2 may be the same or similar to an example of the charger, and detailed description thereof will be omitted.

The retractor cover 5′ may be a protruding body formed to protrude from the body 2.

An inner space 51 in which the retractor module 4 is accommodated may be formed in the retractor cover 5′.

An entrance 52 through which the retractor module 4 enters and exits may be formed in the retractor cover 5′.

A stepped portion 53 on which the seating body 48d of the retractor module 4 may be seated may be recessed in the retractor cover 5′.

A wire through-hole 54 through which the wire 43 of the retractor 4 passes may be formed in the retractor cover 5′.

The inner space 51, the entrance 52, the stepped portion 53, and the wire through-hole 54 may be the same or similar to an example of the charger, and the same symbols are used, and detailed descriptions thereof are omitted.

According to this embodiment, the retractor module may be pulled out from the retractor cover without opening or closing the door, so the retractor may be easily replaced.

In addition, the retractor may be hidden as much as possible by the box and retractor cover, giving the charger a simple outer appearance.

In addition, the retractor module and retractor cover are modularized, improving productivity and enabling common design.

In addition, the convenience of replacing the retractor may be increased by the handle.

In addition, the retractor cover is fixed to the fastening body by a fastening member fastened inside the body, and unless the door is opened, the retractor cover may not be removed, and the retractor cover may be maintained with high reliability.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but are for illustrative purposes, and the scope of the technical idea of the present disclosure is not limited by these embodiments.

The scope of protection of the present disclosure should be interpreted in accordance with the claims below, and all technical ideas within the equivalent scope should be interpreted as being comprised in the scope of rights of the present disclosure.

What is claimed is:

1. A charger configured to charge a battery of a vehicle, the charger comprising:
a body with a space formed inside;
a door configured to open and close the space;
a retractor module comprising:
a retractor, the retractor having a wire connected to a charging cable having a connector configured to connect to a charging port of the vehicle; and
a box configured to cover the retractor; and
a retractor cover disposed on an upper side surface of the body and configured to cover the retractor module when the retractor module is inserted into the retractor cover.

2. The charger of claim 1, wherein the retractor cover comprises:
an inner space configured to accommodate the retractor module;
an entrance through which the retractor module enters and exits; and
a wire through-hole through which the wire passes.

3. The charger of claim 2, wherein a drainage channel is formed on the retractor cover.

4. The charger of claim 3, wherein an opening direction of the wire through-hole and an opening direction of the drainage channel are different.

5. The charger of claim 3, wherein the drainage channel opens toward a rear surface of the door.

6. The charger of claim 3, further comprising:
a door gasket disposed between the body and the door,
wherein the drainage channel is open toward an outside of the door gasket.

7. The charger of claim 1, wherein the retractor module further comprises a handle installed on the box.

8. The charger of claim 1, wherein the box comprises:
a cover base configured to cover one side of the retractor; and
a cover top configured to cover other side of the retractor,
wherein at least one of the cover base or the cover top has an inner through-hole through which the wire passes.

9. The charger of claim 1, wherein the retractor cover comprises:
an inner portion hidden by the door and
an outer portion exposed to an outside of the body.

10. The charger of claim 1, wherein the body comprises:
a fastening body on which the retractor cover is seated and to which the retractor cover is fastened with a fastening member.

11. The charger of claim 10, wherein the fastening body comprises:
a seating portion on which a portion of the retractor cover is seated.

12. The charger of claim 11, wherein the fastening body further comprises:
a fastening portion formed to be long in a vertical direction and having a through-hole through which the fastening member passes.

13. The charger of claim 12, wherein the seating portion is disposed horizontally below the fastening portion.

14. The charger of claim 10, wherein the door is configured to cover the fastening body.

15. The charger of claim 1, wherein the retractor cover comprises a protruding body formed to protrude from the body.

16. The charger of claim 1, wherein a seating body that is seated on the reflector cover is formed on the box.

17. The charger of claim 16, wherein the seating body is bent horizontally at an upper portion of the box.

18. The charger of claim 16, wherein a stepped portion on which the seating body is seated is recessed in an upper portion of the retractor cover.

19. The charger of claim 16,
wherein the retractor comprises a retractor case forming an exterior of the retractor, and
wherein the box covers a front surface, a rear surface, and peripheral surfaces of the retractor.

20. A charger configured to charge a battery of a vehicle, the charger comprising:
a body with a space formed inside;
a door configured to open and close the space;
a retractor having a wire connected to a charging cable having a connector configured to connect to a charging port of the vehicle; and
a retractor cover disposed on an upper side surface of the body and configured to cover the retractor when the retractor is inserted.
